(19) United States
(12) Patent Application Publication
(10) Pub. No.: US 2024/0086291 A1
(43) Pub. Date: Mar. 14, 2024

(54) SELECTIVE CHECKING FOR ERRORS

(71) Applicant: Intel Corporation, Santa Clara, CA (US)

(72) Inventors: Francesc Guim Bernat, Barcelona (ES); Karthik Kumar, Chandler, AZ (US); Amruta Misra, Bangalore (IN)

(73) Assignee: Intel Corporation, Santa Clara, CA (US)

(21) Appl. No.: 17/941,960

(22) Filed: Sep. 9, 2022

(51) Int. Cl. G06F 11/30; G06F 11/07; G06F 11/10

(52) U.S. Cl. CPC G06F 11/3037; G06F 11/0772; G06F 11/1068

(57) ABSTRACT

An apparatus comprising first circuitry to process a request generated by a first device, the request specifying a memory address range of a second device to monitor for errors; and second circuitry to, based on a determination that a read request targets the memory address range of the second device, compare first data read from the second device with second data read from a memory to determine whether an error has occurred.

### FIELD

This disclosure pertains to computing systems, and in particular (but not exclusively) to computer interfaces.

### BACKGROUND

Advances in semi-conductor processing and logic design have permitted an increase in the amount of logic that may be present on integrated circuit devices. As a corollary, computer system configurations have evolved from a single or multiple integrated circuits in a system to multiple cores, multiple hardware threads, and multiple logical processors present on individual integrated circuits, as well as other interfaces integrated within such processors. A processor or integrated circuit typically comprises a single physical processor die, where the processor die may include any number of cores, hardware threads, logical processors, interfaces, memory, controller hubs, etc. As the processing power grows along with the number of devices in a computing system, the communication between sockets and other devices becomes more critical. Accordingly, interconnects, have grown from more traditional multi-drop buses that primarily handled electrical communications to full blown interconnect architectures that facilitate fast communication. Unfortunately, as the demand for future processors to consume at even higher-rates corresponding demand is placed on the capabilities of existing interconnect architectures. Interconnect architectures may be based on a variety of technologies, including Peripheral Component Interconnect Express (PCIe), Universal Serial Bus, and others.

### BRIEF DESCRIPTION OF THE DRAWINGS

FIG. 1 illustrates an embodiment of a computing system including an interconnect architecture.

FIG. 2 illustrates an embodiment of an interconnect architecture including a layered stack.

FIG. 3 illustrates an embodiment of a request or packet to be generated or received within an interconnect architecture.

FIG. 4 illustrates an embodiment of a transmitter and receiver pair for an interconnect architecture.

FIG. 5 illustrates an example implementation of a computing system including a host processor and an accelerator coupled by a link.

FIG. 6 illustrates an example implementation of a computing system including two or more interconnected processor devices.

FIG. 7 illustrates a representation of an example port of a device including a layered stack.

FIG. 8 illustrates an example computing system to provide selective silent data corruption (SDC) error checking.

FIG. 9 illustrates an example switch to facilitate provision of selective Silent Data Corruption (SDC) error checking.

FIG. 10 illustrates example monitoring rules for selective SDC error checking.

FIG. 11 illustrates an example method for selective SDC error checking.

FIG. 12 illustrates an embodiment of a block diagram for a computing system including a multicore processor.

FIG. 13 illustrates another embodiment of a block diagram for a computing system.

### DETAILED DESCRIPTION

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present disclosure. It will be apparent, however, to one skilled in the art that these specific details need not be employed to practice the present disclosure. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present disclosure.

Although the following embodiments may be described with reference to specific integrated circuits, such as in computing platforms or microprocessors, other embodiments are applicable to other types of integrated circuits and logic devices. For example, the disclosed embodiments are not limited to desktop computer systems, but may also be used in other devices, such as handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatuses, methods, and systems described herein are not limited to physical computing devices, but may also relate to software optimizations.

Silent Data Corruption (SDC) errors (sometimes referred to as Silent Data Errors) may refer to errors that go undetected by a device or system (e.g., error code correction techniques utilized by the device or system fail to correct the errors). SDCs may result in data corruption that manifests as application-level errors or bugs, simultaneously resulting in data loss as well. Given such complexities, they are very difficult to debug, and may require large amounts of time to root cause.

Interconnect protocols, such as Compute Express Link (CXL) (e.g., CXL Specification, Revision 3.0, Version 1.0 published Aug. 1, 2022) enable the composition of systems with different types of memory, such as on-board memory in graphics processing units (GPUs) and field programmable gate array (FPGA) devices, CXL drives with dynamic random access memory (DRAM), phase change memory (PCM) technologies, and/or other memory types. These disparate memories may have varying characteristics and offer tradeoffs with respect to cost, performance, and reliability, allowing the end users great flexibility in constructing systems. However, the variances in reliabilities among memory types may also create exposure to SDC errors.

CXL contemplates a rich set of reliability, availability, and serviceability (RAS) capabilities, including link cyclic redundancy check (CRC) and retry, link retraining and recovery, enhanced downstream port control (eDPC), end-to-end CRC (ECRC), hot-plug, data poisoning, and viral (a containment feature). Such RAS capabilities may be expanded to help mitigate SDC errors.

Mirroring and monitoring hundreds of gigabytes of data may be impractical, prohibitive, and wasteful in cases where only a few specific address ranges may require monitoring/mirroring. Various embodiments of the present disclosure provide additional RAS features (e.g., using CXL or other suitable protocol) to mitigate the effects of SDC errors by providing the ability to register specific address ranges to be mirrored and monitored. For example, software running on a device (e.g., application, operating system, etc.) or other logic of the device may request that another device (e.g., a switch or other device coupled to a source device that may issue read requests and a destination device that may host the memory targeted by the read requests) monitors specific address ranges of a cache, storage device, or other suitable memory of the destination device (which may hereinafter be referred to as a monitored memory address range). In various embodiments, the application or device may specify one or more parameters for the monitoring, such as a specific sampling rate for the monitoring, a time interval for the monitoring, and/or specific telemetry based triggers for the monitoring. Thus, various embodiments may provide technical advantages, such as efficient use of resources to check for errors (e.g., SDC or other errors) and detection of errors before propagation to one or more services and applications.

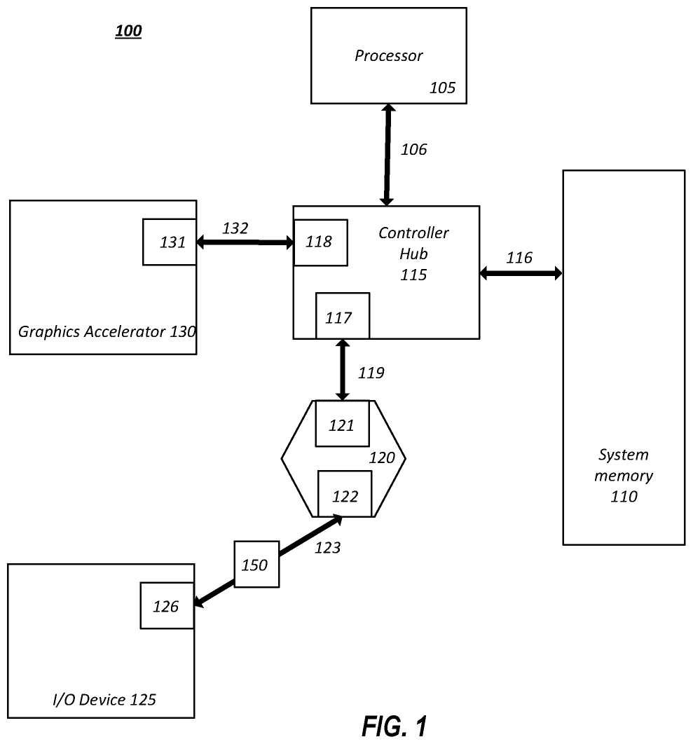

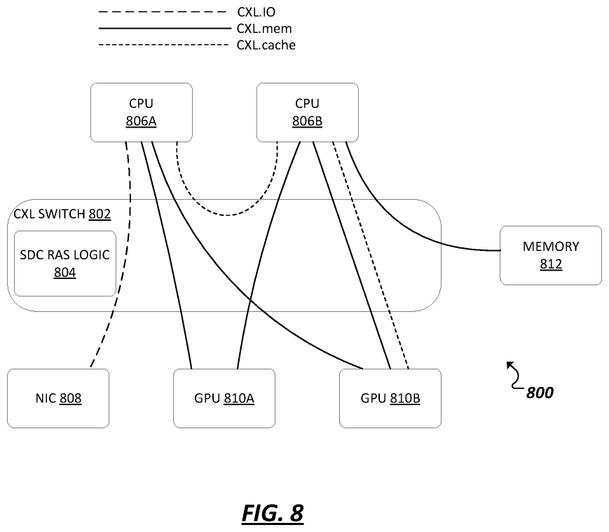

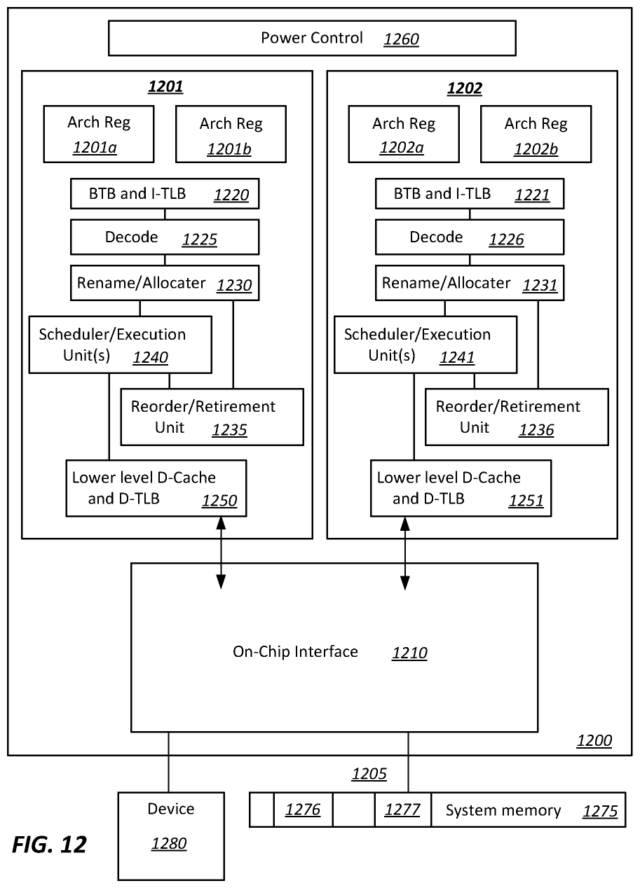

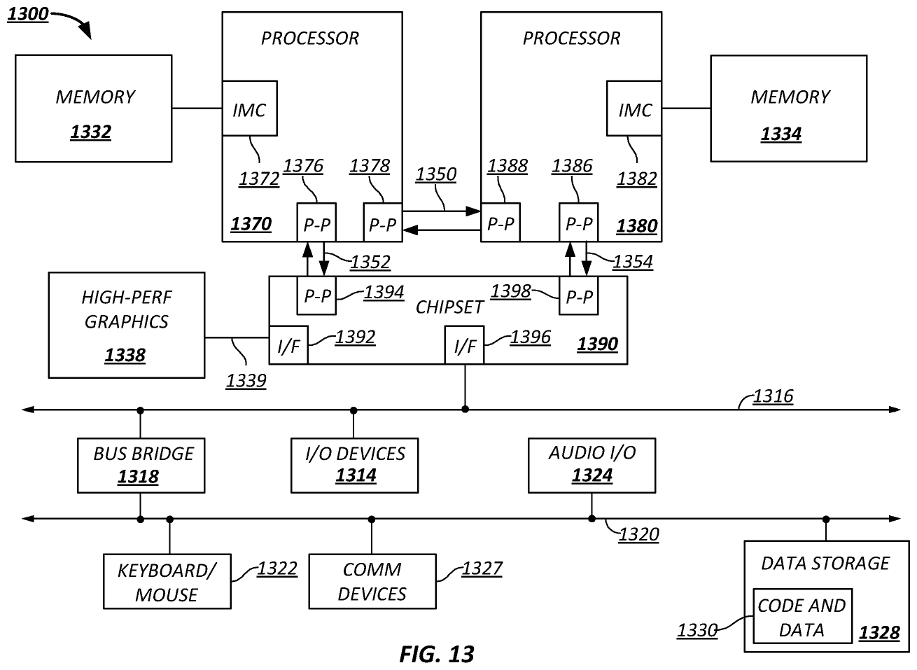

FIGS. 1-7 below describe example characteristics of systems utilizing PCIe, CXL, or other suitable interconnect protocols, FIGS. 8-11 describe error mitigation in more detail, and FIGS. 12-13 describe example systems in which various embodiments of the present disclosure may be utilized.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. However, an aim of most fabrics is to provide an attractive performance vs. power balance. Below, a number of interconnects are discussed, which would potentially benefit from aspects of the solutions described herein.

One interconnect fabric architecture includes the Peripheral Component Interconnect (PCI) Express (PCIe) architecture. A primary goal of PCIe is to enable components and devices from different vendors to inter-operate in an open architecture, spanning multiple market segments; Clients (Desktops and Mobile), Servers (Standard and Enterprise), and Embedded and Communication devices. PCI Express is a high performance, general purpose I/O interconnect defined for a wide variety of future computing and communication platforms. Some PCI attributes, such as its usage model, load-store architecture, and software interfaces, have been maintained through its revisions, whereas previous parallel bus implementations have been replaced by a highly scalable, fully serial interface. The more recent versions of PCI Express take advantage of advances in point-to-point interconnects, Switch-based technology, and packetized protocol to deliver new levels of performance and features. Power Management, Quality Of Service (QoS), Hot-Plug/Hot-Swap support, Data Integrity, and Error Handling are among some of the advanced features supported by PCI Express.

Referring to FIG. 1, an embodiment of a fabric composed of point-to-point Links that interconnect a set of components is illustrated. System 100 includes processor 105 and system memory 110 coupled to controller hub 115. Processor 105 includes any processing element, such as a microprocessor, a host processor, an embedded processor, a co-processor, or other processor. Processor 105 is coupled to controller hub 115 through a link 106 such as front-side bus (FSB). In one embodiment, link 106 is a serial point-to-point interconnect as described below. In other embodiments, link 106 includes a serial, differential interconnect architecture that is compliant with one or more different interconnect standards.

System memory 110 includes any memory device, such as random access memory (RAM), non-volatile (NV) memory, or other memory accessible by devices in system 100. System memory 110 is coupled to controller hub 115 through memory interface 116. Examples of a memory interface include a double-data rate (DDR) memory interface, a dual-channel DDR memory interface, and a dynamic RAM (DRAM) memory interface.

In one embodiment, controller hub 115 is a root hub, root complex, or root controller in a Peripheral Component Interconnect Express (PCIe or PCIE) interconnection hierarchy. Examples of controller hub 115 include a chipset, a memory controller hub (MCH), a northbridge, an interconnect controller hub (ICH) a southbridge, and a root controller/hub. Often the term chipset refers to two physically separate controller hubs, e.g., a memory controller hub (MCH) coupled to an interconnect controller hub (ICH). Note that current systems often include the MCH integrated with processor 105, while controller hub 115 is to communicate with I/O devices, in a similar manner as described below. In some embodiments, peer-to-peer routing is optionally supported through controller hub 115.

Here, controller hub 115 is coupled to switch/bridge 120 through serial link 119. Input/output modules 117 and 121, which may also be referred to as interfaces/ports 117 and 121, include/implement a layered protocol stack to provide communication between controller hub 115 and switch 120. In one embodiment, multiple devices are capable of being coupled to switch 120.

Switch/bridge 120 routes packets/messages from device 125 upstream, e.g., up a hierarchy towards a root complex, to controller hub 115 and downstream, e.g., down a hierarchy away from a root controller, from processor 105 or system memory 110 to device 125. Switch 120, in one embodiment, is referred to as a logical assembly of multiple virtual PCI-to-PCI bridge devices. Device 125 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, and other input/output devices. Often in the PCIe vernacular, such as device, is referred to as an endpoint. Although not specifically shown, device 125 may include a PCIe to PCI/PCI-X bridge to support legacy or other version PCI devices. Endpoint devices in PCIe are often classified as legacy, PCIe, or root complex integrated endpoints.

Graphics accelerator 130 is also coupled to controller hub 115 through serial link 132. In one embodiment, graphics accelerator 130 is coupled to an MCH, which is coupled to an ICH. Switch 120, and accordingly I/O device 125, is then coupled to the ICH. I/O modules 131 and 118 (also referred to as interfaces) are also to implement a layered protocol stack to communicate between graphics accelerator 130 and controller hub 115. Similar to the MCH discussion above, a graphics controller or the graphics accelerator 130 itself may be integrated in processor 105. It should be appreciated that one or more of the components (e.g., 105, 110, 115, 120, 125, 130) illustrated in FIG. 1 can be enhanced to execute, store, and/or embody logic to implement one or more of the features described herein.

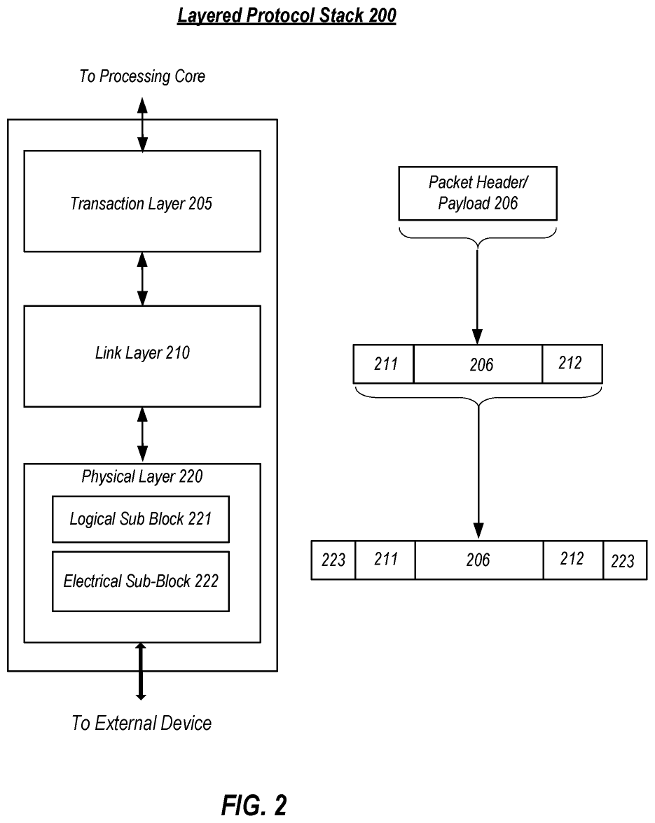

Turning to FIG. 2 an embodiment of a layered protocol stack is illustrated. Layered protocol stack 200 includes any form of a layered communication stack, such as a Quick Path Interconnect (QPI) stack, a PCIe stack, a next generation high performance computing interconnect stack, or other layered stack. Although the discussion immediately below in reference to FIGS. 1-4 are in relation to a PCIe stack, the same concepts may be applied to other interconnect stacks. In one embodiment, protocol stack 200 is a PCIe protocol stack including transaction layer 205, link layer 210, and physical layer 220. An interface, such as interfaces 117, 118, 121, 122, 126, and 131 in FIG. 1, may be represented as communication protocol stack 200. Representation as a communication protocol stack may also be referred to as a module or interface implementing/including a protocol stack.

PCI Express uses packets to communicate information between components. Packets are formed in the Transaction Layer 205 and Data Link Layer 210 to carry the information from the transmitting component to the receiving component. As the transmitted packets flow through the other layers, they are extended with additional information necessary to handle packets at those layers. At the receiving side the reverse process occurs and packets get transformed from their Physical Layer 220 representation to the Data Link Layer 210 representation and finally (for Transaction Layer Packets) to the form that can be processed by the Transaction Layer 205 of the receiving device.

Transaction Layer

In one embodiment, transaction layer 205 is to provide an interface between a device's processing core and the interconnect architecture, such as data link layer 210 and physical layer 220. In this regard, a primary responsibility of the transaction layer 205 is the assembly and disassembly of packets (e.g., transaction layer packets, or TLPs). The transaction layer 205 typically manages credit-based flow control for TLPs. PCIe implements split transactions, e.g., transactions with request and response separated by time, allowing a link to carry other traffic while the target device gathers data for the response.

In addition PCIe utilizes credit-based flow control. In this scheme, a device advertises an initial amount of credit for each of the receive buffers in Transaction Layer 205. An external device at the opposite end of the link, such as controller hub 115 in FIG. 1, counts the number of credits consumed by each TLP. A transaction may be transmitted if the transaction does not exceed a credit limit. Upon receiving a response an amount of credit is restored. An advantage of a credit scheme is that the latency of credit return does not affect performance, provided that the credit limit is not encountered.

In one embodiment, four transaction address spaces include a configuration address space, a memory address space, an input/output address space, and a message address space. Memory space transactions include one or more of read requests and write requests to transfer data to/from a memory-mapped location. In one embodiment, memory space transactions are capable of using two different address formats, e.g., a short address format, such as a 32-bit address, or a long address format, such as 64-bit address. Configuration space transactions are used to access configuration space of the PCIe devices. Transactions to the configuration space include read requests and write requests. Message transactions are defined to support in-band communication between PCIe agents.

Therefore, in one embodiment, transaction layer 205 assembles packet header/payload 156. Format for current packet headers/payloads may be found in the PCIe specification at the PCIe specification website.

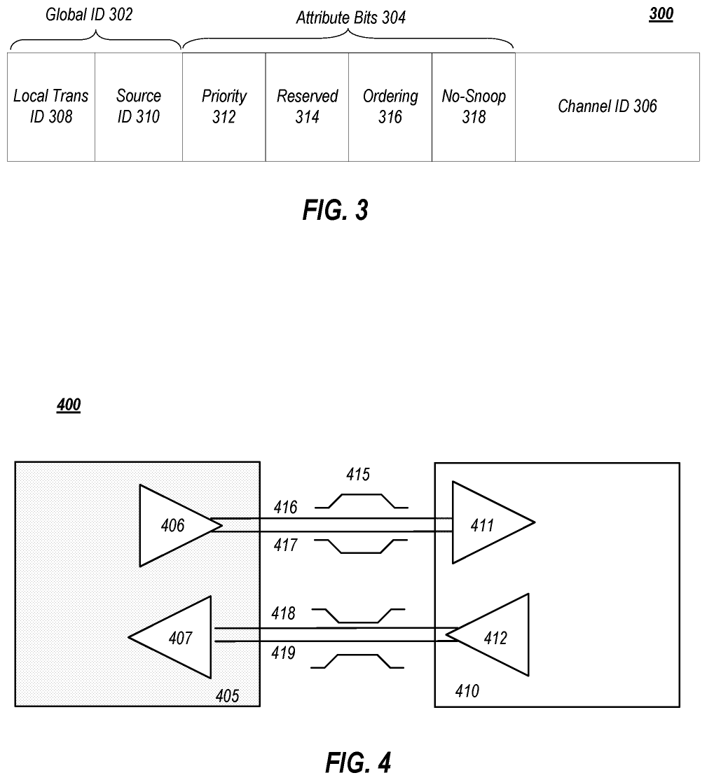

Quickly referring to FIG. 3, an embodiment of a PCIe transaction descriptor is illustrated. In one embodiment, transaction descriptor 300 is a mechanism for carrying transaction information. In this regard, transaction descriptor 300 supports identification of transactions in a system. Other potential uses include tracking modifications of default transaction ordering and association of transaction with channels.

Transaction descriptor 300 includes global identifier field 302, attributes field 304 and channel identifier field 306. In the illustrated example, global identifier field 302 is depicted comprising local transaction identifier field 308 and source identifier field 310. In one embodiment, global identifier field 302 is unique for all outstanding requests.

According to one implementation, local transaction identifier field 308 is a field generated by a requesting agent, and it is unique for all outstanding requests that require a completion for that requesting agent. Furthermore, in this example, source identifier 310 uniquely identifies the requestor agent within a PCIe hierarchy. Accordingly, together with source ID 310, local transaction identifier 308 field provides global identification of a transaction within a hierarchy domain.

Attributes field 304 specifies characteristics and relationships of the transaction. In this regard, attributes field 304 is potentially used to provide additional information that allows modification of the default handling of transactions. In one embodiment, attributes field 304 includes priority field 312, reserved field 314, ordering field 316, and no-snoop field 318. Here, priority field 312 may be modified by an initiator to assign a priority to the transaction. Reserved attribute field 314 is left reserved for future, or vendor-defined usage. Possible usage models using priority or security attributes may be implemented using the reserved attribute field.

In this example, ordering attribute field 316 is used to supply optional information conveying the type of ordering that may modify default ordering rules. According to one example implementation, an ordering attribute of “0” denotes default ordering rules are to apply, wherein an ordering attribute of “1” denotes relaxed ordering, wherein writes can pass writes in the same direction, and read completions can pass writes in the same direction. No-snoop attribute field 318 is utilized to determine if transactions are snooped. As shown, channel ID Field 306 identifies a channel that a transaction is associated with.

Link Layer

Link layer 210, also referred to as data link layer 210, acts as an intermediate stage between transaction layer 205 and the physical layer 220. In one embodiment, a responsibility of the data link layer 210 is providing a reliable mechanism for exchanging Transaction Layer Packets (TLPs) between two components a link. One side of the Data Link Layer 210 accepts TLPs assembled by the Transaction Layer 205, applies packet sequence identifier 211, e.g., an identification number or packet number, calculates and applies an error detection code, e.g., CRC 212, and submits the modified TLPs to the Physical Layer 220 for transmission across a physical to an external device.

Physical Layer

In one embodiment, physical layer 220 includes logical sub block 221 and electrical sub-block 222 to physically transmit a packet to an external device. Here, logical sub-block 221 is responsible for the “digital” functions of Physical Layer 220. In this regard, the logical sub-block includes a transmit section to prepare outgoing information for transmission by electrical sub-block 222, and a receiver section to identify and prepare received information before passing it to the Link Layer 210.

Physical layer 220 includes a transmitter and a receiver. The transmitter is supplied by logical sub-block 221 with symbols, which the transmitter serializes and transmits onto to an external device. The receiver is supplied with serialized symbols from an external device and transforms the received signals into a bit-stream. The bit-stream is de-serialized and supplied to logical sub-block 221. In one embodiment, an 8 b/10 b transmission code is employed, where ten-bit symbols are transmitted/received. Here, special symbols are used to frame a packet with frames 223. In addition, in one example, the receiver also provides a symbol clock recovered from the incoming serial stream.

As stated above, although transaction layer 205, link layer 210, and physical layer 220 are discussed in reference to a specific embodiment of a PCIe protocol stack, a layered protocol stack is not so limited. In fact, any layered protocol may be included/implemented. As an example, an port/interface that is represented as a layered protocol includes: (1) a first layer to assemble packets, e.g., a transaction layer; a second layer to sequence packets, e.g., a link layer; and a third layer to transmit the packets, e.g., a physical layer. As a specific example, a common standard interface (CSI) layered protocol is utilized.

Referring next to FIG. 4, an embodiment of a PCIe serial point to point fabric is illustrated. Although an embodiment of a PCIe serial point-to-point link is illustrated, a serial point-to-point link is not so limited, as it includes any transmission path for transmitting serial data. In the embodiment shown, a basic PCIe link includes two, low-voltage, differentially driven signal pairs: a transmit pair 406/412 and a receive pair 411/407. Accordingly, device 405 includes transmission logic 406 to transmit data to device 410 and receiving logic 407 to receive data from device 410. In other words, two transmitting paths, e.g., paths 416 and 417, and two receiving paths, e.g., paths 418 and 419, are included in a PCIe link.

A transmission path refers to any path for transmitting data, such as a transmission line, a copper line, an optical line, a wireless communication channel, an infrared communication link, or other communication path. A connection between two devices, such as device 405 and device 410, is referred to as a link, such as link 415. A link may support one lane—each lane representing a set of differential signal pairs (one pair for transmission, one pair for reception). To scale bandwidth, a link may aggregate multiple lanes denoted by xN, where N is any supported Link width, such as 1, 2, 4, 8, 12, 16, 32, 64, or wider. In some implementations, each symmetric lane contains one transmit differential pair and one receive differential pair. Asymmetric lanes can contain unequal ratios of transmit and receive pairs. Some technologies can utilize symmetric lanes (e.g., PCIe), while others (e.g., Displayport) may not and may even including only transmit or only receive pairs, among other examples.

A differential pair refers to two transmission paths, such as lines 416 and 417, to transmit differential signals. As an example, when line 416 toggles from a low voltage level to a high voltage level, e.g., a rising edge, line 417 drives from a high logic level to a low logic level, e.g., a falling edge. Differential signals potentially demonstrate better electrical characteristics, such as better signal integrity, e.g., cross-coupling, voltage overshoot/undershoot, ringing, etc. This allows for better timing window, which enables faster transmission frequencies.

A variety of interconnect architectures and protocols may utilize the concepts discussed herein. With advancements in computing systems and performance requirements, improvements to interconnect fabric and link implementations continue to be developed, including interconnects based on or utilizing elements of PCIe or other legacy interconnect platforms. In one example, CXL has been developed, providing an improved, high-speed central processing unit (CPU)-to-device and CPU-to-memory interconnect designed to accelerate next-generation data center performance, among other application. In some instances, CXL may maintain memory coherency between the CPU memory space and memory on attached devices, which allows resource sharing for higher performance, reduced software stack complexity, and lower overall system cost, among other example advantages. CXL enables communication between devices such as host processors (e.g., CPUs) and a set of workload accelerators (e.g., graphics processing units (GPUs), field programmable gate array (FPGA) devices, tensor and vector processor units, machine learning accelerators, purpose-built accelerator solutions, or other devices among other examples). Indeed, CXL is designed to provide a standard interface for high-speed communications, as accelerators are increasingly used to complement CPUs in support of emerging computing applications such as artificial intelligence, machine learning and other applications.

A CXL link may be a low-latency, high-bandwidth discrete or on-package link that supports dynamic protocol multiplexing of coherency, memory access, and input/output (I/O) protocols. Among other applications, a CXL link may enable an accelerator to access system memory as a caching agent and/or host system memory, among other examples. CXL is a multi-protocol technology designed to support a vast spectrum of accelerators. CXL provides a set of protocols that include I/O semantics similar to PCIe (CXL.io), caching protocol semantics (CXL.cache), and memory access semantics (CXL.mem) over a discrete or on-package link. Based on the particular accelerator usage model, all of the CXL protocols or only a subset of the protocols may be enabled. In some implementations, CXL may be built upon the well-established, widely adopted PCIe infrastructure (e.g., PCIe 5.0), leveraging the PCIe physical and electrical interface to provide advanced protocol in areas include I/O, memory protocol (e.g., allowing a host processor to share memory with an accelerator device), and coherency interface.

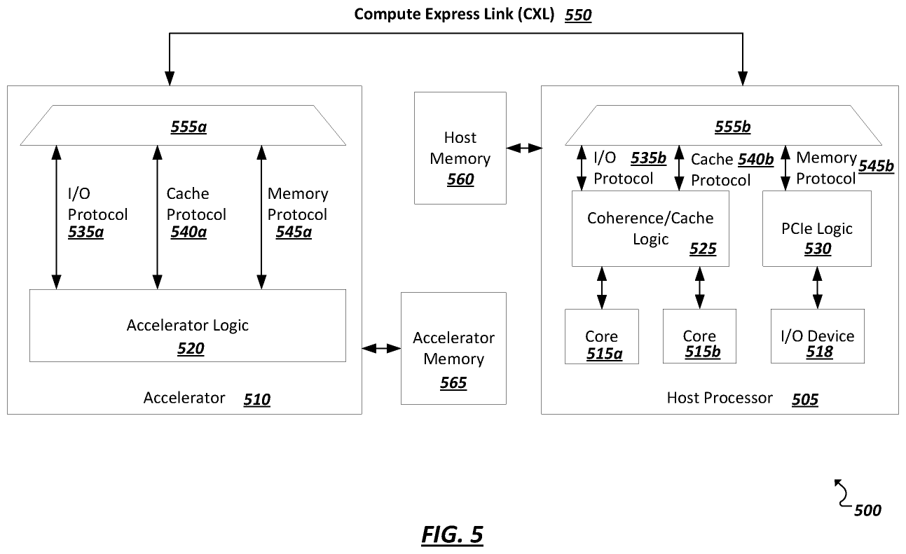

Turning to FIG. 5, a simplified block diagram 500 is shown illustrating an example system utilizing a CXL link 550. For instance, the link 550 may interconnect a host processor 505 (e.g., CPU) to an accelerator device 510. In this example, the host processor 505 includes one or more processor cores (e.g., 515a-b) and one or more I/O devices (e.g., 518). Host memory (e.g., 560) may be provided with the host processor (e.g., on the same package or die). The accelerator device 510 may include accelerator logic 520 and, in some implementations, may include its own memory (e.g., accelerator memory 565). In this example, the host processor 505 may include circuitry to implement coherence/cache logic 525 and interconnect logic (e.g., PCIe logic 530). CXL multiplexing logic (e.g., 555a-b) may also be provided to enable multiplexing of CXL protocols (e.g., I/O protocol 535a-b (e.g., CXL.io), caching protocol 540a-b (e.g., CXL.cache), and memory access protocol 545a-b (CXL.mem)), thereby enabling data of any one of the supported protocols (e.g., 535a-b, 540a-b, 545a-b) to be sent, in a multiplexed manner, over the link 550 between host processor 505 and accelerator device 510.

In some implementations, a Flex Bus™ port may be utilized in concert with CXL-compliant links to flexibly adapt a device to interconnect with a wide variety of other devices (e.g., other processor devices, accelerators, switches, memory devices, etc.). A Flex Bus port is a flexible high-speed port that is statically configured to support either a PCIe or CXL link (and potentially also links of other protocols and architectures). A Flex Bus port allows designs to choose between providing native PCIe protocol or CXL over a high-bandwidth, off-package link. Selection of the protocol applied at the port may happen during boot time via auto negotiation and be based on the device that is plugged into the slot. Flex Bus uses PCIe electricals, making it compatible with PCIe retimers, and adheres to standard PCIe form factors for an add-in card.

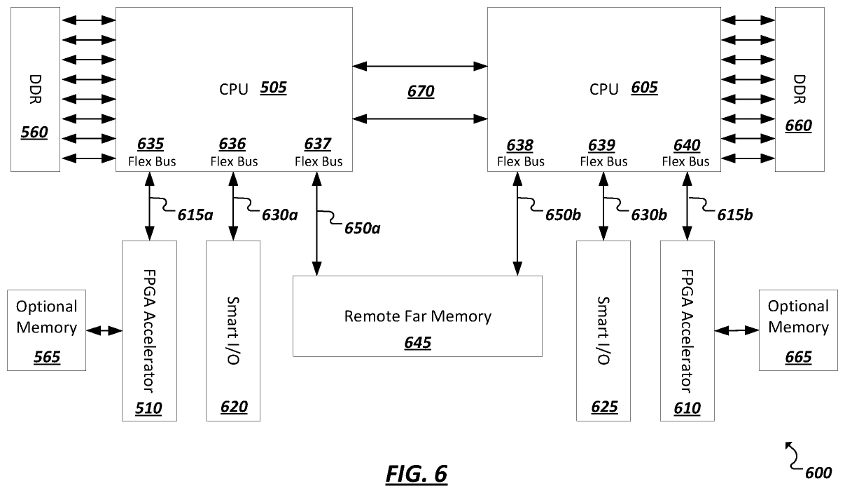

Turning to FIG. 6, an example is shown (in simplified block diagram 600) of a system utilizing Flex Bus ports (e.g., 635-640) to implement CXL (e.g., 615a-b, 650a-b) and PCIe links (e.g., 630a-b) to couple a variety of devices (e.g., 510, 610, 620, 625, 645, etc.) to a host processor (e.g., CPU 505, 605). In this example, a system may include two CPU host processor devices (e.g., 505, 605) interconnected by an inter-processor link 670 (e.g., utilizing a UltraPath Interconnect (UPI), Infinity Fabric™, or other interconnect protocol). Each host processor device 505, 605 may be coupled to local system memory blocks 560, 660 (e.g., double data rate (DDR) memory devices), coupled to the respective host processor 505, 605 via a memory interface (e.g., memory bus or other interconnect).

As discussed above, CXL links (e.g., 615a, 650b) may be utilized to interconnect a variety of accelerator devices (e.g., 510, 610). Accordingly, corresponding ports (e.g., Flex Bus ports 635, 640) may be configured (e.g., CXL mode selected) to enable CXL links to be established and interconnect corresponding host processor devices (e.g., 505, 605) to accelerator devices (e.g., 510, 610). As shown in this example, Flex Bus ports (e.g., 636, 639), or other similarly configurable ports, may be configured to implement general purpose I/O links (e.g., PCIe links) 630a-b instead of CXL links, to interconnect the host processor (e.g., 505, 605) to I/O devices (e.g., smart I/O devices 620, 625, etc.). In some implementations, memory of the host processor 505 may be expanded, for instance, through the memory (e.g., 565, 665) of connected accelerator devices (e.g., 510, 610), or memory extender devices (e.g., 645, connected to the host processor(s) 505, 605 via corresponding CXL links (e.g., 650a-b) implemented on Flex Bus ports (637, 638), among other example implementations and architectures.

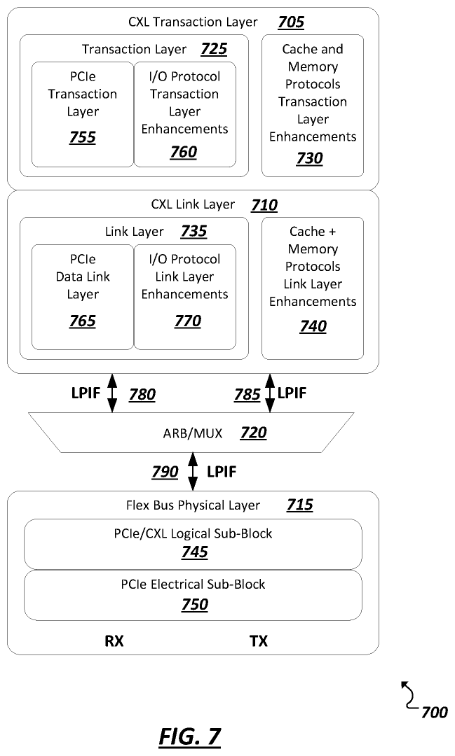

FIG. 7 is a simplified block diagram illustrating an example port architecture 700 (e.g., Flex Bus) utilized to implement CXL links. For instance, Flex Bus architecture may be organized as multiple layers to implement the multiple protocols supported by the port. For instance, the port may include transaction layer logic (e.g., 705), link layer logic (e.g., 710), and physical layer logic (e.g., 715) (e.g., implemented all or in-part in circuitry). For instance, a transaction (or protocol) layer (e.g., 705) may be subdivided into transaction layer logic 725 that implements a PCIe transaction layer 755 and CXL transaction layer enhancements 760 (for CXL.io) of a base PCIe transaction layer 755, and logic 730 to implement cache (e.g., CXL.cache) and memory (e.g., CXL.mem) protocols for a CXL link. Similarly, link layer logic 735 may be provided to implement a base PCIe data link layer 765 and a CXL link layer (for CXl.io) representing an enhanced version of the PCIe data link layer 765. A CXL link layer 710 may also include cache and memory link layer enhancement logic 740 (e.g., for CXL.cache and CXL.mem).

Continuing with the example of FIG. 7, a CXL link layer logic 710 may interface with CXL arbitration/multiplexing (ARB/MUX) logic 720, which interleaves the traffic from the two logic streams (e.g., PCIe/CXL.io and CXL.cache/CXL.mem), among other example implementations. During link training, the transaction and link layers are configured to operate in either PCIe mode or CXL mode. In some instances, a host CPU may support implementation of either PCIe or CXL mode, while other devices, such as accelerators, may only support CXL mode, among other examples. In some implementations, the port (e.g., a Flex Bus port) may utilize a physical layer 715 based on a PCIe physical layer (e.g., PCIe electrical PHY 750). For instance, a Flex Bus physical layer may be implemented as a converged logical physical layer 745 that can operate in either PCIe mode or CXL mode based on results of alternate mode negotiation during the link training process. In some implementations, the physical layer may support multiple signaling rates (e.g., 8 GT/s, 16 GT/s, 32 GT/s, etc.) and multiple link widths (e.g., ×16, ×8, ×4, ×2, ×1, etc.). In PCIe mode, links implemented by the port 700 may be fully compliant with native PCIe features (e.g., as defined in the PCIe specification), while in CXL mode, the link supports all features defined for CXL. Accordingly, a Flex Bus port may provide a point-to-point interconnect that can transmit native PCIe protocol data or dynamic multi-protocol CXL data to provide I/O, coherency, and memory protocols, over PCIe electricals, among other examples.

The CXL I/O protocol, CXL.io, provides a non-coherent load/store interface for I/O devices. Transaction types, transaction packet formatting, credit-based flow control, virtual channel management, and transaction ordering rules in CXL.io may follow all or a portion of the PCIe definition. CXL cache coherency protocol, CXL.cache, defines the interactions between the device and host as a number of requests that each have at least one associated response message and sometimes a data transfer. The interface consists of three channels in each direction: Request, Response, and Data.

The CXL memory protocol, CXL.mem, is a transactional interface between the processor and memory and uses the physical and link layers of CXL when communicating across dies. CXL.mem can be used for multiple different memory attach options including when a memory controller is located in the host CPU, when the memory controller is within an accelerator device, or when the memory controller is moved to a memory buffer chip, among other examples. CXL.mem may be applied to transactions involving different memory types (e.g., volatile, persistent, etc.) and configurations (e.g., flat, hierarchical, etc.), among other example features. In some implementations, a coherency engine of the host processor may interface with memory using CXL.mem requests and responses. In this configuration, the CPU coherency engine is regarded as the CXL.mem Master and the Mem device is regarded as the CXL.mem Subordinate. The CXL.mem Master is the agent which is responsible for sourcing CXL.mem requests (e.g., reads, writes, etc.) and a CXL.mem Subordinate is the agent which is responsible for responding to CXL.mem requests (e.g., data, completions, etc.). When the Subordinate is an accelerator, CXL.mem protocol assumes the presence of a device coherency engine (DCOH). This agent is assumed to be responsible for implementing coherency related functions such as snooping of device caches based on CXL.mem commands and update of metadata fields. In implementations, where metadata is supported by device-attached memory, it can be used by the host to implement a coarse snoop filter for CPU sockets, among other example uses.

In some implementations, an interface may be provided to couple circuitry or other logic (e.g., an intellectual property (IP) block or other hardware element) implementing a link layer (e.g., 710) to circuitry or other logic (e.g., an IP block or other hardware element) implementing at least a portion of a physical layer (e.g., 715) of a protocol. For instance, an interface based on a Logical PHY Interface (LPIF) specification to define a common interface between a link layer controller, module, or other logic and a module implementing a logical physical layer (“logical PHY” or “logPHY”) to facilitate interoperability, design and validation re-use between one or more link layers and a physical layer for an interface to a physical interconnect, such as in the example of FIG. 7. Additionally, as in the example of FIG. 7, an interface may be implemented with logic (e.g., 735, 740) to simultaneously implement and support multiple protocols. Further, in such implementations, an arbitration and multiplexer layer (e.g., 720) may be provided between the link layer (e.g., 710) and the physical layer (e.g., 715). In some implementations, each block (e.g., 715, 720, 735, 740) in the multiple protocol implementation may interface with the other block via an independent LPIF interface (e.g., 780, 785, 790). In cases where bifurcation is supported, each bifurcated port may likewise have its own independent LPIF interface, among other examples.

While examples discussed herein may reference the use of LPIF-based link layer-logical PHY interfaces, it should be appreciated that the details and principles discussed herein may be equally applied to non-LPIF interfaces. Likewise, while some examples may reference the use of common link layer-logical PHY interfaces to couple a PHY to controllers implement CXL or PCIe, other link layer protocols may also make use of such interfaces. Similarly, while some references may be made to Flex Bus physical layers, other physical layer logic may likewise be employed in some implementations and make use of common link layer-logical PHY interfaces, such as discussed herein, among other example variations that are within the scope of the present disclosure.

FIG. 8 illustrates an example computing system 800 to provide selective error detection (e.g., SDC error detection). System 800 comprises a CXL switch 802 including SDC RAS logic 804. The CXL switch 802 may comprise a device that connects various other devices together, including CPUs 806A and 806B, NIC 808, GPUs 810A and 810B, and memory 812 in the depicted embodiment.

The SDC RAS logic 804 may receive a request from a software stack (e.g., an operating system, application, etc.) or other logic of a device connected to the CXL switch 802 to monitor a memory address range (e.g., a range that is expected to be critical) of another device. For example, an application running on CPU 806A could request monitoring of a 128 kilobyte (KB) structure hosted on GPU 810A.

The SDC RAS logic 804 may be operable to detect writes to the monitored memory address range and store (e.g., cache) the write data locally on the CXL domain logic (e.g., in a memory of the CXL switch 802) and send the writes to the target device (that includes the monitored memory address range). These writes may originate from the device (e.g., CPU 806A) that requested the monitoring or from another device coupled to the CXL switch 802 (e.g., CPU 806B, GPU 810B, etc.).

The SDC RAS logic 804 may also intercept read operations (either sequential or random reads) from a device (e.g., the device that requested the monitoring or other device) and determine whether they target a monitored memory address range. If a read does not target a monitored memory address range, the SDC RAS logic 804 may allow the read to proceed normally. If the read targets a monitored memory address range, the data may be read from the device (that hosts the monitored memory address range) and compared against the corresponding data from the memory of the CXL switch 802. If one or more differences is detected, an SDC error may be reported to the device requesting the read (and could be reported specifically to the specific entity of the device that requested the read, such as the operating system or application). The data read from the target device as well as the data read from the memory of the CXL switch 802 may also be provided to the device requesting the read.

In some embodiments, the data stored (e.g., cached) at the CXL switch may also be replicated within the CXL switch 802 (and compared against the cached data at the time of the read) to mitigate against SDC errors that may occur within the CXL switch 802.

In other embodiments, instead of checking for SDC errors for every read operation targeting the monitored memory address range, the CXL switch 802 may periodically perform comparisons between read data and data stored (e.g., cached) locally on the CXL switch 802 for SDC errors based on a sampling rate. The sampling rate could be a default sampling rate (e.g., configured internally within the CXL switch 802) or a sampling rate specified by the device requesting the monitoring (e.g., at the time the monitoring is requested). The checking may also be limited by a time interval specified by the device requesting the monitoring and if the current time is not within the time interval than a standard read from the targeted memory address may be performed without checking for SDC errors.

In the embodiment depicted, various communications are shown utilizing different protocols. For example, the CPU 806A communicates with the NIC 808 utilizing the CXL.IO protocol, with the GPUs 810A and 810B utilizing the CXL.mem protocols, and with CPU 806B using the CXL.cache protocol. CPU 806B also communicates with GPUs 810A and 810B using the CXL.mem protocol and additionally communicates with GPU 810B utilizing the CXL.cache protocol and with memory 812 using the CXL.mem protocol. As shown various protocols may be used to communicate among the devices. Various embodiments herein may provide for selective SDC checking for data stored at any of these devices which may be written to or read from using any (or a subset) of the displayed protocols and/or any other suitable protocol.

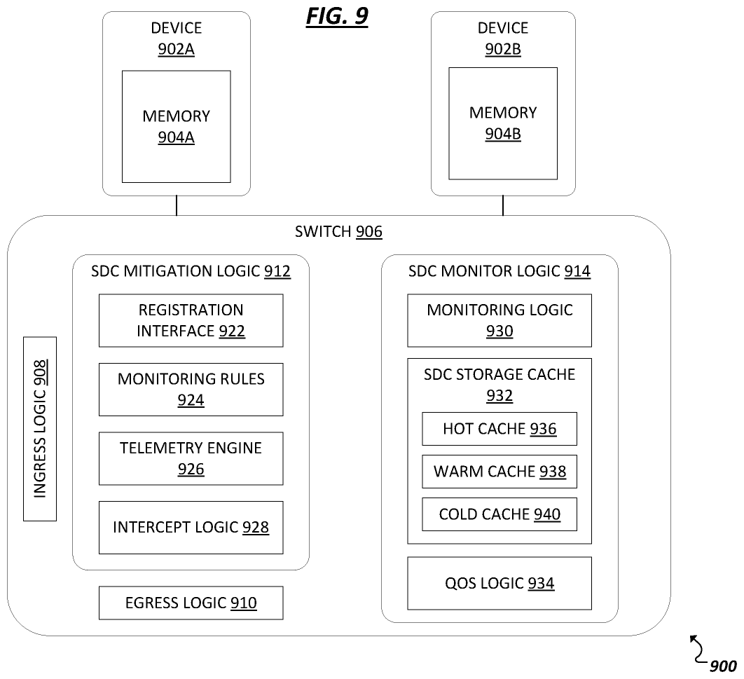

FIG. 9 illustrates an example switch 906 to facilitate provision of SDC error detection. In some embodiments, switch 906 may correspond to CXL switch 802 or other suitable device connected to multiple devices that transports read and write requests between the devices. In various embodiments, SDC mitigation logic 912 and SDC monitor 914 may correspond to SDC RAS logic 804 or other suitable logic that may be implemented on a device to provide selective SDC error checking.

Switch 906 may couple any number of devices 902 together (where in some embodiments a device may correspond to either a device and/or a host as defined by a communication specification (e.g., CXL)). In the embodiment depicted, device 902A is coupled to device 902B via switch 906. A device 902 may comprise memory (e.g., 904A, 904B) that may be written to and read from by one or more other devices 902 coupled to the switch 906.

Switch 906 comprises ingress logic 908 and egress logic 910 which may respectively control the flow of communications entering and leaving the switch 906. Switch 906 further comprises SDC mitigation logic 912 and SDC monitor logic 914. SDC mitigation logic 912 comprises registration interface 922, monitoring rules 924, telemetry engine 926, and intercept logic 928. SDC monitor logic 916 comprising monitoring logic 930, SDC storage cache 932 (or other suitable memory), and QoS logic 934.

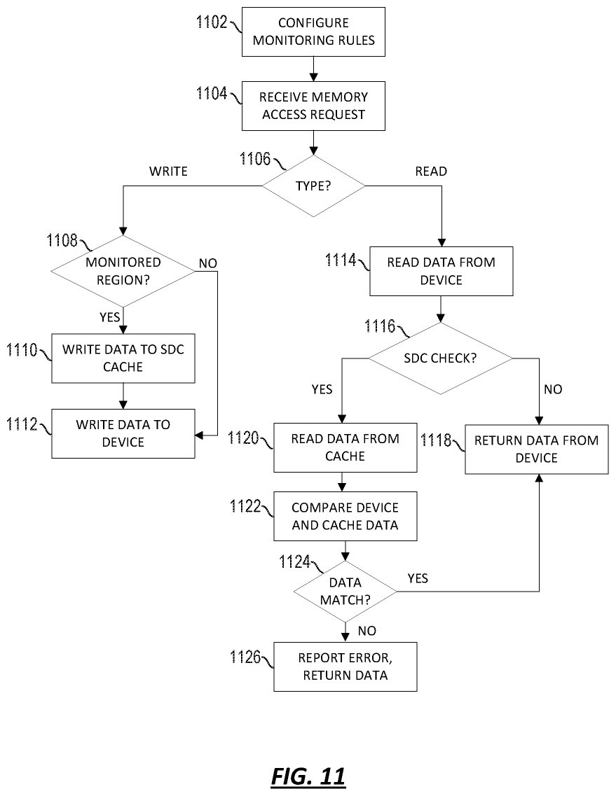

Registration interface 922 may receive and process registration and deregistration requests for selective SDC checking from any suitable device 902. Information included in or derived from the registration request during processing of the registration request may be stored in monitoring rules 924 (to be illustrated further in connection with FIG. 11). In some embodiments, processing a registration request may include verifying that the parameters within the registration request are valid and/or sending a confirmation that the request will be implemented, a denial indicating the request will not be implemented, or other communication with respect to the registration request (e.g., a modification of one or more parameters of the request) to the device submitting the registration request.

A registration request may include any suitable information identifying an address range to be mirrored in the SDC storage cache 932 and monitored for SDC errors. For example, a registration request may include a memory address range that is to be monitored. The memory address range may be specified in any suitable manner, such as by a start address and an address size or a start address and an end address. In various embodiments, the memory address range may be a logical address range (in other embodiments the memory address range may be a physical address range). In some instances, multiple address ranges to be monitored may be supplied in a registration request. In various embodiments, the registration request may also include an identifier of the device (sometimes referred to herein as a destination device) that hosts the memory address range to be monitored.

In some embodiments, a registration request may include an identification of one or more devices that may be the source of a read request that should be checked by the switch 906 for SDC errors. Thus, reads to the monitored address range by any one of these specified devices may be compared against corresponding data stored (e.g., cached) by the switch 906 to determine if SDC errors are present (whereas reads to the monitored address range by another device would not be subject to SDC error checking). This SDC error checking may be done on all reads performed by any of these specified devices or on only a portion of such reads (e.g., in accordance with one or more other parameters of the registration request, such as a sampling rate, protocol type, sampling type, etc. as described below). In some embodiments, the selective SDC error checking may be performed for any source device of a read targeting the monitored address range or only for the device that sent the registration request.

In various embodiments, the registration request may include various parameters defining when SDC error checking is to be performed. For example, the registration request may specify a sampling rate that indicates how often data read from the monitored range is to be checked for SDC errors. For example, the sampling rate may specify a frequency (e.g., test a memory line every other microsecond). As another example, the sampling rate may specify a ratio (e.g., test one of every one hundred memory lines read). The sampling rate may be applied in the aggregate across all sources performing the reads or respective sampling rates could be applied for each source.

As another example, the registration request may specify one or more time intervals over which the monitored range is to be checked for SDC errors. For example, a device (e.g., through an application of the device) may request the SDC error checking in conjunction with critical operations and may specify a time duration that covers the period over which the critical operations are expected to be performed. Again, the time intervals may be applied for all sources performing the reads or respective time intervals could be applied for each source.

As another example, the registration request may specify one or more particular protocols that are to be monitored. For example, with respect to the CXL protocol, the registration request could specify whether one or more of CXL.mem, CXL.io, and CXL.cache read requests are to be checked for SDC errors.

As another example, the registration request may specify a sampling type. For example, the sampling type may specify whether the SDC error checking is to be performed sequentially or randomly. For example, when the sampling type is sequential, SDC error checking may be performed at a regular cadence (e.g., once every millisecond); whereas when the sampling type is random, SDC error checking may be performed at random intervals (e.g., a first check may be performed at 0.85 milliseconds, a second check performed at 2.12 milliseconds, a third check performed at 2.95 milliseconds, etc.). The random intervals may be selected based on the sampling rate (e.g., by introducing random variance to the sampling rate). In other embodiments, the sampling type could specify whether multiple SDC error checks for a monitored area are to be performed on contiguously read memory lines or on randomly spaced memory lines. In yet other embodiments, the sampling type may specify whether the SDC error checking is to be performed on sequential reads, random reads, or both.

The registration request may also specify other parameters to assist the switch 906 in implementing the selective SDC error checking. For example, a registration request may include a priority of the monitored memory address region (e.g., to guide the switch 906 as to how to store the mirrored region and/or how often to check for SDC errors), QoS parameters for the monitored memory address region, or other suitable parameters.

The registration interface 922 may also receive deregistration requests. Such a request may specify any suitable information to allow cessation of the monitoring of all or a portion of a monitored memory address range. In some embodiments, a deregistration request may specify a memory range that should no longer be monitored for SDC errors. In some instances, the memory range in a deregistration request from a device may match the memory range in a registration request received earlier from the device, in which case monitoring of the entire memory address range may be stopped. In other instances, the memory address range in a deregistration request may specify only a portion of a memory address range of a registration request from the same device. In this case, the switch 906 may stop monitoring that portion, but may continue monitoring the remaining portion of the memory address range. In some embodiments, a deregistration request may also specify the device hosting the memory to be deregistered. In other embodiments, other suitable information may be included in the deregistration request. For example, an identifier (e.g., a UUID) associated with the original registration request (e.g., which may be returned to the requesting device responsive to the registration request) may be provided in the deregistration request, allowing the switch 906 to deregister the memory range(s) specified in the registration request matching that identifier.

Telemetry engine 926 may collect data associated with the SDC error checking. For example, the telemetry engine 926 may track SDC errors detected with any suitable granularity, such as the number of SDC errors per monitored address range, per device 902, or in the aggregate across devices 902. The SDC errors may be tracked over any suitable time periods. The telemetry engine 926 may also track the number of monitored address ranges (e.g., of each device or across all connected devices) for which at least one SDC error has been detected.

The telemetry engine 926 may also track other indications that may be associated with the incidence of SDC errors. In doing so, the telemetry engine 926 may communicate with any suitable device or component thereof. For example, telemetry engine 926 may track a number of correctable errors (as these are often correlated with SDC errors) at any suitable granularity (e.g., per monitored memory region, per device, per connection between devices, etc.). As another example, telemetry engine 926 may track an amount of traffic to or from a particular device or between two devices. As other examples, telemetry engine 926 may track temperature, current, or voltage at any suitable point(s) within the switch 906 or devices 902.

In some embodiments, telemetry engine 926 (or other logic of the switch 906 that is in communication with the telemetry engine 926) may submit a registration request to the registration interface 922 or submit a request to alter a monitoring rule based on telemetry data collected by the telemetry engine 926 (which could be collected from a source device(s), the switch 906, and/or a destination device). For example, if at least one SDC error is detected in a monitored memory address region at a low sampling rate, a request to raise the sampling rate for the monitored address region may be generated and sent to the registration interface. As another example, if quality of service (QoS) metrics are not being met (e.g., as measured by QoS logic 934), the telemetry engine 926 or other logic of the switch could adjust the sampling rate for one or more relevant monitoring rules or otherwise request changes to the monitoring rules to preserve sufficient performance quality. As another example, if a threshold number of correctable errors are detected for a particular device hosting memory, a registration request for a memory address region of that memory may be submitted to the registration interface 922. The telemetry engine 926 (or associated logic), could also submit a deregistration request to the registration interface 922 in some instances based on the telemetry data (e.g., if no SDC errors are detected for a monitored region for a threshold amount of time).

Intercept logic 928 may analyze incoming read and write requests to determine whether the request specifies a memory location that is within a monitored range. Additional actions with respect to SDC error checking may be taken if the request specifies a memory location within a monitored range.

With respect to a write request, intercept logic 928 may utilize a system address decoder to determine whether the write request targets a monitored memory address range. If the write request does not target a monitored memory address range, then the write may proceed as normal. If the write request does target a monitored memory address range, then the write value of the write request may be stored within SDC storage cache 932 and also written to the memory location within the monitored memory address range of the device specified in the write request.

With respect to a read request, intercept logic 928 may again utilize a system address decoder (which could be the same address decoder used for write requests or a different system address decoder) to determine whether the read request targets a monitored memory address range. If the read request does not target a monitored memory address range, then the read may proceed normally to the specified device. If the read request does target a monitored memory address range and this particular read is to be checked for SDC errors, then the read may be performed at the specified device (e.g., the device hosting the memory location of the monitored memory address range). The corresponding data in the SDC storage cache 932 may also be read and compared against the data read from the device. If the two values match, then the value is returned to the device that sent the read request. If the two values do not match, then an indication of the error is reported to the device that sent the read request. The error may be reported in any suitable manner. For example, an interrupt indicating that an SDC error has occurred may be generated and provided to the requesting device. In some embodiments, both read values (from the device and from the SDC storage cache 932) may be returned to the device requesting the read. In other embodiments, either the value from the device or the value from the SDC storage cache 932 may be returned to the device requesting the read along with an indication of the SDC error.

The determination of whether a write or read request targets a monitored memory address range may be performed in any suitable manner using any suitable format and/or portion of a memory address. For example, a logical memory address in a write or read request may be compared against a logical memory address range in a monitoring rule. As another example, a logical memory address of a write or read request may be translated into another logical memory address or a physical address and may be compared against a corresponding memory address range in a monitoring rule. Other suitable determinations are contemplated.

The SDC monitor logic 914 is responsible to perform the SDC error checking on the memory ranges that have been registered for selective SDC checking via the SDC mitigation logic 912. In various embodiments, the SDC monitor logic 914 may perform an SDC error check for each read request to a monitored memory address range. In other embodiments, the SDC monitor logic 914 may perform the SDC error check on only a portion of the read requests to a monitored memory address range. For example, whether an SDC error check is performed may depend on the monitoring rules for the monitored memory address range. For example, an SDC error check may not be performed when the source device, protocol, and/or time interval requirements of the monitoring rule is not satisfied by the read request. As another example, whether an SDC error check is performed may depend on the sampling rate set for the monitored memory address range (in some embodiments, only a small fraction of read requests targeting the monitored memory address range result in an SDC error check by the monitoring logic 930).

The SDC storage cache 932 is responsible to store (e.g., cache) values written to monitored memory address ranges for checking against values read from the relevant device(s) 902. In various embodiments, the SDC storage cache 932 may include different portions (which could include differing storage media and/or different configurations) that may provide varying levels of performance, power, and/or reliability for caching of different monitored memory ranges. In the embodiment depicted, the SDC storage cache 932 includes a hot cache 936, a warm cache 938, and a cold cache 940. The varying levels of caches shown could refer to differing performance characteristics of the caches (e.g., hot cache 936 may have the highest performance) and/or the age of data stored in the respective caches (e.g., hot cache 936 may store data that has been most recently accessed, cold cache 940 may store data that was least recently accessed, etc.). The different types of caches may be used by the switch 906 (e.g., via any suitable control logic, which could be a part of any of the components of the switch 906) to optimize one or more of power consumption, performance, or reliability (in some embodiments, the optimizations may be based on one or more parameters of the registration requests indicating relative priority, latency requirements, power usage requirements, or other characteristics associated with address ranges to be checked for SDC errors). For example, low priority memory ranges may be cached within media which utilizes a relatively small amount of power (and may incidentally be slower than other media of the cache 932). As another example, monitored ranges for high demand write applications may be cached in higher performance storage media. As yet another example, in order to improve reliability (e.g., when an application is especially sensitive to SDC errors), cached data may be replicated within multiple caches of the SDC storage cache 932 to mitigate the risk of introducing an SDC error by the switch 906.

Responsive to signals from the SDC mitigation logic 912 (e.g., signals originated by the intercept logic 928), monitoring logic 930 may perform reads of the SDC storage cache 932 and perform SDC error checking by comparing the read values against values read from monitored memory address ranges of devices 902. The reads may be either sequential or random. Monitoring logic 930 may also report a detected SDC error to the device requesting the read (and could more specifically report the error to an entity within the device, such as an application, operating system, or other entity that requested the read) along with the data read from the device and/or the data read from the cache 932. The value may also be marked as invalid within the SDC storage cache 932. In some embodiments, a detected error may initiate a process in which the switch 906 reports the error to a device 902 requesting the read and the device responds with the correct value (e.g., the device may request the value from disk or other location and then provide it to the switch 906 for inclusion within SDC storage cache 932). Although various embodiments refer to “caches”, this disclosure contemplates utilizing any suitable memories to store the values.

QoS logic 934 may track any suitable QoS metrics (e.g., latency, bandwidth, etc.) and may initiate less frequent SDC error checking (e.g., by communicating with registration interface 922 to change monitoring rules or through other means) in various cases in which the QoS metrics are not being met.

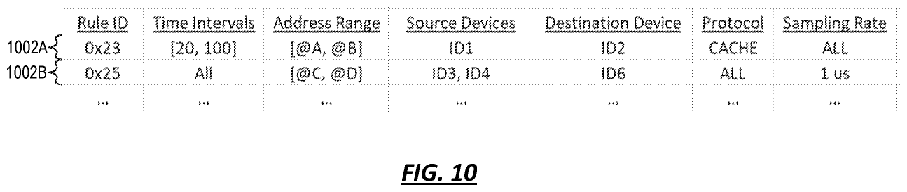

FIG. 10 illustrates example monitoring rules 1002 for selective SDC error detection. In this embodiment, each monitoring rule includes a rule ID, one or more time intervals, one or more address ranges, one or more source devices, a destination device, one or more protocols, and a sampling rate.

Monitoring rule 1002A has a rule ID of 0x23 and monitoring rule 1002B has a rule ID of 0x23. The rule ID may be any suitable ID (e.g., a Universal Unique Identifier (UUID)) that uniquely identifies a monitoring rule among the monitoring rules.

Monitoring rule 1002A specifies a time interval of [20,100] and monitoring rule 1002B has a time interval of all. The units of the time intervals may be specified within the registration request or could be implied between the devices and the switch. The time interval may be specified in any suitable manner such as a start time an end time and/or a duration of time. When the time interval of all is set, the monitoring may continue indefinitely, e.g., until the monitoring rule is deregistered.

Monitoring rule 1002A has an address range of [@A, @B] and monitoring rule 1002B has an address range of [@C, @D], where @A and @C are start addresses and @B and @D are end addresses.

The source devices and destination devices of the monitoring rules 1002 may be identified using any suitable identifiers that uniquely identify the devices. In one embodiment, the IDs may comprise process address space IDs (PASIDs).

Monitoring rule 1002A specifies that only CXL.cache communications will be subject to SDC error checking, while monitoring rule 1002B specifies that CXL.io, CXL.mem, and CXL.cache communications will be subject to SDC error checking. Monitoring rule 1002A specifies that all read requests will be checked for SDC errors, while monitoring rule 1002B specifies that one read request every microsecond will be checked for SDC errors.

FIG. 11 illustrates an example method for selective SDC error detection. The method may be performed by any suitable device of a communication network, such as a device (e.g., a switch) that communicates read and write requests from and to other devices.

At 1102, monitoring rules are configured. Registration requests may be received from any number of different devices and monitoring rules may be configured therefrom. At 1104, a memory access request is received (e.g., from one of the connected device). At 1106, the method forks based on whether the memory access request is a write request or a read request.

If the request is a write request, at 1108 a determination is made as to whether the write request specifies a memory address that is part of a monitored memory address region. If it does not, the flow moves to 1112, where the data is written to the destination device (e.g., the device receiving the write request may forward the write request to the destination device). If the memory address is part of a monitored memory address region, then along with writing the data to the device, the data is written to the SDC cache at 1110.

If the request is a read request, then data is read from the destination device at 1114 according to the read request (e.g., the device receiving the read request may forward the read request to the destination device and receive the read data in response). At 1116 a determination as to whether a check for SDC errors is to be performed for the read request. If it is not, the data read from the device is returned to the device that requested the read at 1118.

If an SDC check is to be performed, data is read from the cache at 1120 (e.g., the address in the read request may be used to retrieve the data from the cache). At 1122, the data read from the destination device and the data read from the cache are compared.

A determination of whether the data read from the cache and the data read from the destination device matches is made at 1124. If there is a match, the data read from the device is returned to the device that provided the read request. If there is not a match, then an error is reported and the mismatched data is returned to the device requesting the read at 1126.

The flow described in FIG. 11 is merely representative of operations that may occur in particular embodiments. In other embodiments, additional operations may be performed. Various embodiments of the present disclosure contemplate any suitable signaling mechanisms for accomplishing the functions described herein. Some of the operations illustrated in FIG. 11 may be repeated, combined, modified or omitted where appropriate. Additionally, operations may be performed in any suitable order without departing from the scope of particular embodiments.

Although various embodiments of the present disclosure are discussed with respect to a switch (e.g., a CXL switch) and the CXL protocol, features of the various embodiments may be applied to any suitable device (e.g., switch, router, or other suitable device) that is connected to multiple devices and coordinates read and write requests among the devices. In various embodiments, each device (e.g., 902, switch 906 or other device including logic to implement selective SDC checking, any of the devices shown in FIG. 8, etc.) could be on a different die or package, or multiple devices could be integrated on the same die or package.

In various embodiments, instead of the CXL protocol, any suitable protocol that supports reading from and writing to memory on interconnected devices may be used. Example protocols that may be used in various embodiments may include Peripheral Component Interconnect (PCI), PCI express (PCIe), PCIx, Universal Chiplet Interconnect Express (UCIe), Intel On-chip System Fabric (IOSF), Gen-Z, Open Coherent Accelerator Processor Interface (OpenCAPI), Serial ATA, USB, UltraPath Interconnect (UPI), and Infinity Fabric™.

Note that the apparatuses, methods, and systems described above may be implemented in any electronic device or system as aforementioned. As specific illustrations, the figures below provide exemplary systems for utilizing the concepts as described herein. For instance, components illustrated in the following examples may be implemented on separate dies or packages, and such components may be coupled together by a switch or other device that implements selective SDC checking for the components. As the systems below are described in more detail, a number of different interconnects are disclosed, described, and revisited from the discussion above. And as is readily apparent, the advances described above may be applied to any of those interconnects, fabrics, or architectures.

Referring to FIG. 12, an embodiment of a block diagram for a computing system including a multicore processor is depicted. Processor 1200 includes any processor or processing device, such as a microprocessor, an embedded processor, a digital signal processor (DSP), a network processor, a handheld processor, an application processor, a co-processor, a system on a chip (SOC), or other device to execute code. Processor 1200, in one embodiment, includes at least two cores-core 1201 and 1202, which may include asymmetric cores or symmetric cores (the illustrated embodiment). However, processor 1200 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 1200, as illustrated in FIG. 12, includes two cores-core 1201 and 1202. Here, core 1201 and 1202 are considered symmetric cores, e.g., cores with the same configurations, functional units, and/or logic. In another embodiment, core 1201 includes an out-of-order processor core, while core 1202 includes an in-order processor core. However, cores 1201 and 1202 may be individually selected from any type of core, such as a native core, a software managed core, a core adapted to execute a native Instruction Set Architecture (ISA), a core adapted to execute a translated Instruction Set Architecture (ISA), a co-designed core, or other known core. In a heterogeneous core environment (e.g., asymmetric cores), some form of translation, such as a binary translation, may be utilized to schedule or execute code on one or both cores. Yet to further the discussion, the functional units illustrated in core 1201 are described in further detail below, as the units in core 1202 operate in a similar manner in the depicted embodiment.

Core 1201, in some embodiments, may include two hardware threads, which may also be referred to as hardware thread slots. Therefore, software entities, such as an operating system, in one embodiment potentially view processor 1200 as four separate processors, e.g., four logical processors or processing elements capable of executing four software threads concurrently. As alluded to above, a first thread is associated with architecture state registers 1201a, a second thread is associated with architecture state registers 1201b, a third thread may be associated with architecture state registers 1202a, and a fourth thread may be associated with architecture state registers 1202b. Here, each of the architecture state registers (1201a, 1201b, 1202a, and 1202b) may be referred to as processing elements, thread slots, or thread units, as described above. As illustrated, architecture state registers 1201a are replicated in architecture state registers 1201b, so individual architecture states/contexts are capable of being stored for a first logical processor (associated with 1201a) and a second logical processor (associated with 1201b). In core 1201, other smaller resources, such as instruction pointers and renaming logic in allocator and renamer block 1230 may also be replicated for threads 1201a and 1201b. Some resources, such as re-order buffers in reorder/retirement unit 1235, ILTB 1220, load/store buffers, and queues may be shared through partitioning. Other resources, such as general-purpose internal registers, page-table base register(s), low-level data-cache and data-TLB 1215, execution unit(s) 1240, and portions of out-of-order unit 1235 are potentially fully shared.

Processor 1200 often includes other resources, which may be fully shared, shared through partitioning, or dedicated by/to processing elements. In FIG. 12, an embodiment of a purely exemplary processor with illustrative logical units/resources of a processor is illustrated. Note that a processor may include, or omit, any of these functional units, as well as include any other known functional units, logic, or firmware not depicted. As illustrated, core 1201 includes a simplified, representative out-of-order (OOO) processor core. But an in-order processor may be utilized in different embodiments. The OOO core includes a branch target buffer 1220 to predict branches to be executed/taken and an instruction-translation buffer (I-TLB) 1220 to store address translation entries for instructions.

Core 1201 further includes decode module 1225 coupled to a fetch unit (e.g., including 1220) to decode fetched elements. Fetch logic, in one embodiment, includes individual sequencers associated with thread slots associated with architecture state registers 1201a, 1201b, respectively. Usually core 1201 is associated with a first ISA, which defines/specifies instructions executable on processor 1200. Often machine code instructions that are part of the first ISA include a portion of the instruction (referred to as an opcode), which references/specifies an instruction or operation to be performed. Decode logic 1225 includes circuitry that recognizes these instructions from their opcodes and passes the decoded instructions on in the pipeline for processing as defined by the first ISA. For example, as discussed in more detail below decoders 1225, in one embodiment, include logic designed or adapted to recognize specific instructions, such as transactional instruction. As a result of the recognition by decoders 1225, the architecture or core 1201 takes specific, predefined actions to perform tasks associated with the appropriate instruction. It is important to note that any of the tasks, blocks, operations, and methods described herein may be performed in response to a single or multiple instructions; some of which may be new or old instructions. Note decoders 1226, in one embodiment, recognize the same ISA (or a subset thereof). Alternatively, in a heterogeneous core environment, decoders 1226 recognize a second ISA (either a subset of the first ISA or a distinct ISA).

In one example, allocator and renamer block 1230 includes an allocator to reserve resources, such as register files to store instruction processing results. However, threads associated with 1201a and 1201b are potentially capable of out-of-order execution, where allocator and renamer block 1230 also reserves other resources, such as reorder buffers to track instruction results. Block 1230 may also include a register renamer to rename program/instruction reference registers to other registers internal to processor 1200. Reorder/retirement unit 1235 includes components, such as the reorder buffers mentioned above, load buffers, and store buffers, to support out-of-order execution and later in-order retirement of instructions executed out-of-order.

Scheduler and execution unit(s) block 1240, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 1250 are coupled to execution unit(s) 1240. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 1201 and 1202 share access to higher-level or further-out cache, such as a second level cache associated with on-chip interface 1210. Note that higher-level or further-out refers to cache levels increasing or getting further way from the execution unit(s). In one embodiment, higher-level cache is a last-level data cache—last cache in the memory hierarchy on processor 1200—such as a second or third level data cache. However, higher level cache is not so limited, as it may be associated with or include an instruction cache. A trace cache-a type of instruction cache—instead may be coupled after decoder 1225 to store recently decoded traces. Here, an instruction potentially refers to a macro-instruction (e.g., a general instruction recognized by the decoders), which may decode into a number of micro-instructions (micro-operations).

In the depicted configuration, processor 1200 also includes on-chip interface module 1210. Historically, a memory controller, which is described in more detail below, has been included in a computing system external to processor 1200. In this scenario, on-chip interface 1210 is to communicate with devices external to processor 1200, such as system memory 1275, a chipset (often including a memory controller hub to connect to memory 1275 and an I/O controller hub to connect peripheral devices), a memory controller hub, a northbridge, or other integrated circuit. And in this scenario, bus 1205 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 1275 may be dedicated to processor 1200 or shared with other devices in a system. Common examples of types of memory 1275 include DRAM, SRAM, non-volatile memory (NV memory), and other known storage devices. Note that device 1280 may include a graphic accelerator, processor or card coupled to a memory controller hub, data storage coupled to an I/O controller hub, a wireless transceiver, a flash device, an audio controller, a network controller, or other known device.

Recently however, as more logic and devices are being integrated on a single die, such as SOC, each of these devices may be incorporated on processor 1200. For example, in one embodiment, a memory controller hub is on the same package and/or die with processor 1200. Here, a portion of the core (an on-core portion) such as on-chip interface 1210 includes one or more controller(s) for interfacing with other devices such as memory 1275 or a graphics device 1280. The configuration including an interconnect and controllers for interfacing with such devices is often referred to as an on-core (or un-core configuration). As an example, on-chip interface 1210 includes a ring interconnect for on-chip communication and a high-speed serial point-to-point link (e.g., bus 1205) for off-chip communication. Yet, in the SOC environment, even more devices, such as the network interface, co-processors, memory 1275, graphics device 1280, and any other known computer devices/interface may be integrated on a single die or integrated circuit to provide small form factor with high functionality and low power consumption.

In one embodiment, processor 1200 is capable of executing a compiler, optimization, and/or translator code 1277 to compile, translate, and/or optimize application code 1276 to support the apparatus and methods described herein or to interface therewith.

Referring now to FIG. 13, shown is a block diagram of a second system 1300 in accordance with an embodiment of the present solutions. As shown in FIG. 13, multiprocessor system 1300 is a point-to-point interconnect system, and includes a first processor 1370 and a second processor 1380 coupled via a point-to-point interconnect 1350. Each of processors 1370 and 1380 may be some version of a processor. In one embodiment, 1352 and 1354 are part of a serial, point-to-point coherent (or non-coherent) interconnect fabric.

While shown with only two processors 1370, 1380, it is to be understood that the scope of the present disclosure is not so limited. In other embodiments, one or more additional processors may be present in a given processor.

Processors 1370 and 1380 are shown including integrated memory controller units 1372 and 1382, respectively. Processor 1370 also includes as part of its bus controller units point-to-point (P-P) interfaces 1376 and 1378; similarly, second processor 1380 includes P-P interfaces 1386 and 1388. Processors 1370, 1380 may exchange information via a point-to-point (P-P) interface 1350 using P-P interface circuits 1378, 1388. As shown in FIG. 13, IMCs 1372 and 1382 couple the processors to respective memories, namely a memory 1332 and a memory 1334, which may be portions of main memory locally attached to the respective processors.

Processors 1370, 1380 each exchange information with a chipset 1390 via individual P-P interfaces 1352, 1354 using point to point interface circuits 1376, 1394, 1386, 1398. Chipset 1390 also exchanges information with a high-performance graphics circuit 1338 via an interface circuit 1392 along a high-performance graphics interconnect 1339.

A shared cache (not shown) may be included in either processor or outside of both processors; yet connected with the processors via P-P interconnect, such that either or both processors' local cache information may be stored in the shared cache if a processor is placed into a low power mode.

Chipset 1390 may be coupled to a first bus 1316 via an interface 1396. In one embodiment, first bus 1316 may be a Peripheral Component Interconnect (PCI) bus, or a bus such as a PCI Express bus or another third generation I/O interconnect bus, although the scope of the present disclosure is not so limited.

As shown in FIG. 13, various I/O devices 1314 are coupled to first bus 1316, along with a bus bridge 1318 which couples first bus 1316 to a second bus 1320. In one embodiment, second bus 1320 includes a low pin count (LPC) bus. Various devices are coupled to second bus 1320 including, for example, a keyboard and/or mouse 1322, communication devices 1327 and a storage unit 1328 such as a disk drive or other mass storage device which often includes instructions/code and data 1330, in one embodiment. Further, an audio I/O 1324 is shown coupled to second bus 1320. Note that other architectures are possible, where the included components and interconnect architectures vary. For example, instead of the point-to-point architecture of FIG. 13, a system may implement a multi-drop bus or other such architecture.

Computing systems can include various combinations of components. These components may be implemented as ICs, portions thereof, discrete electronic devices, or other modules, logic, hardware, software, firmware, or a combination thereof adapted in a computer system, or as components otherwise incorporated within a chassis of the computer system. However, it is to be understood that some of the components shown may be omitted, additional components may be present, and different arrangement of the components shown may occur in other implementations. As a result, the features and components described above may be implemented in any portion of one or more of the interconnects illustrated or described below.

A processor, in one embodiment, includes a microprocessor, multi-core processor, multithreaded processor, an ultra-low voltage processor, an embedded processor, or other known processing element. In the illustrated implementation, processor acts as a main processing unit and central hub for communication with many of the various components of the system. As one example, processor is implemented as a system on a chip (SoC). As a specific illustrative example, processor includes an Intel® Architecture Core™-based processor such as an i3, i5, i7 or another such processor available from Intel Corporation, Santa Clara, CA. However, understand that other low power processors such as available from Advanced Micro Devices, Inc. (AMD) of Sunnyvale, CA, a MIPS-based design from MIPS Technologies, Inc. of Sunnyvale, CA, an ARM-based design licensed from ARM Holdings, Ltd. or customer thereof, or their licensees or adopters may instead be present in other embodiments such as an Apple A5/A6 processor, a Qualcomm Snapdragon processor, or TI OMAP processor. Note that many of the customer versions of such processors are modified and varied; however, they may support or recognize a specific instruction set that performs defined algorithms as set forth by the processor licensor. Here, the microarchitectural implementation may vary, but the architectural function of the processor is usually consistent. Certain details regarding the architecture and operation of processor in one implementation will be discussed further below to provide an illustrative example.

Processor, in one embodiment, communicates with a system memory. As an illustrative example, which in an embodiment can be implemented via multiple memory devices to provide for a given amount of system memory. As examples, the memory can be in accordance with a Joint Electron Devices Engineering Council (JEDEC) low power double data rate (LPDDR)-based design such as the current LPDDR2 standard according to JEDEC JESD 209-2E (published April 2009), or a next generation LPDDR standard to be referred to as LPDDR3 or LPDDR4 that will offer extensions to LPDDR2 to increase bandwidth. In various implementations the individual memory devices may be of different package types such as single die package (SDP), dual die package (DDP) or quad die package (13P). These devices, in some embodiments, are directly soldered onto a motherboard to provide a lower profile solution, while in other embodiments the devices are configured as one or more memory modules that in turn couple to the motherboard by a given connector. And of course, other memory implementations are possible such as other types of memory modules, e.g., dual inline memory modules (DIMMs) of different varieties including but not limited to microDIMMs, MiniDIMMs. In a particular illustrative embodiment, memory is sized between 2 GB and 16 GB, and may be configured as a DDR3LM package or an LPDDR2 or LPDDR3 memory that is soldered onto a motherboard via a ball grid array (BGA).

To provide for persistent storage of information such as data, applications, one or more operating systems and so forth, a mass storage may also couple to processor. In various embodiments, to enable a thinner and lighter system design as well as to improve system responsiveness, this mass storage may be implemented via an SSD. However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. A flash device may be coupled to processor, e.g., via a serial peripheral interface (SPI). This flash device may provide for non-volatile storage of system software, including a basic input/output software (BIOS) as well as other firmware of the system.

In various embodiments, mass storage of the system is implemented by an SSD alone or as a disk, optical or other drive with an SSD cache. In some embodiments, the mass storage is implemented as an SSD or as an HDD along with a restore (RST) cache module. In various implementations, the HDD provides for storage of between 320 GB-4 terabytes (TB) and upward while the RST cache is implemented with an SSD having a capacity of 24 GB-256 GB. Note that such SSD cache may be configured as a single level cache (SLC) or multi-level cache (MLC) option to provide an appropriate level of responsiveness. In an SSD-only option, the module may be accommodated in various locations such as in a mSATA or NGFF slot. As an example, an SSD has a capacity ranging from 120 GB-1 TB.

Various peripheral devices may couple to processor via a low pin count (LPC) interconnect. In the embodiment shown, various components can be coupled through an embedded controller. Such components can include a keyboard (e.g., coupled via a PS2 interface), a fan, and a thermal sensor. In some embodiments, touch pad may also couple to EC via a PS2 interface. In addition, a security processor such as a trusted platform module (TPM) in accordance with the Trusted Computing Group (TCG) TPM Specification Version 1.2, dated Oct. 2, 2003, may also couple to processor via this LPC interconnect. However, understand the scope of the present disclosure is not limited in this regard and secure processing and storage of secure information may be in another protected location such as a static random access memory (SRAM) in a security coprocessor, or as encrypted data blobs that are only decrypted when protected by a secure enclave (SE) processor mode.

In a particular implementation, peripheral ports may include a high definition media interface (HDMI) connector (which can be of different form factors such as full size, mini or micro); one or more USB ports, such as full-size external ports in accordance with the Universal Serial Bus Revision 3.0 Specification (November 2008), with at least one powered for charging of USB devices (such as smartphones) when the system is in Connected Standby state and is plugged into AC wall power. In addition, one or more Thunderbolt™ ports can be provided. Other ports may include an externally accessible card reader such as a full-size SD-XC card reader and/or a SIM card reader for WWAN (e.g., an 8-pin card reader). For audio, a 3.5 mm jack with stereo sound and microphone capability (e.g., combination functionality) can be present, with support for jack detection (e.g., headphone only support using microphone in the lid or headphone with microphone in cable). In some embodiments, this jack can be re-taskable between stereo headphone and stereo microphone input. Also, a power jack can be provided for coupling to an AC brick.

System can communicate with external devices in a variety of manners, including wirelessly. In some instances, various wireless modules, each of which can correspond to a radio configured for a particular wireless communication protocol, are present. One manner for wireless communication in a short range such as a near field may be via a near field communication (NFC) unit which may communicate, in one embodiment with processor via an SMBus. Note that via this NFC unit, devices in close proximity to each other can communicate. For example, a user can enable system to communicate with another (e.g.,) portable device such as a smartphone of the user via adapting the two devices together in close relation and enabling transfer of information such as identification information payment information, data such as image data or so forth. Wireless power transfer may also be performed using an NFC system.

Using the NFC unit described herein, users can bump devices side-to-side and place devices side-by-side for near field coupling functions (such as near field communication and wireless power transfer (WPT)) by leveraging the coupling between coils of one or more of such devices. More specifically, embodiments provide devices with strategically shaped, and placed, ferrite materials, to provide for better coupling of the coils. Each coil has an inductance associated with it, which can be chosen in conjunction with the resistive, capacitive, and other features of the system to enable a common resonant frequency for the system.

Further, additional wireless units can include other short-range wireless engines including a WLAN unit and a Bluetooth unit. Using WLAN unit, Wi-Fi™ communications in accordance with a given Institute of Electrical and Electronics Engineers (IEEE) 802.11 standard can be realized, while via Bluetooth unit, short range communications via a Bluetooth protocol can occur. These units may communicate with processor via, e.g., a USB link or a universal asynchronous receiver transmitter (UART) link. Or these units may couple to processor via an interconnect according to a Peripheral Component Interconnect Express™ (PCIe™) protocol, e.g., in accordance with the PCI Express™ Specification Base Specification version 3.0 (published Jan. 17, 2007), or another such protocol such as a serial data input/output (SDIO) standard. Of course, the actual physical connection between these peripheral devices, which may be configured on one or more add-in cards, can be by way of the NGFF connectors adapted to a motherboard.

In addition, wireless wide area communications, e.g., according to a cellular or other wireless wide area protocol, can occur via a WWAN unit which in turn may couple to a subscriber identity module (SIM). In addition, to enable receipt and use of location information, a GPS module may also be present. WWAN unit and an integrated capture device such as a camera module may communicate via a given USB protocol such as a USB 2.0 or 3.0 link, or a UART or I²C protocol. Again, the actual physical connection of these units can be via adaptation of a NGFF add-in card to an NGFF connector configured on the motherboard.

In a particular embodiment, wireless functionality can be provided modularly, e.g., with a WiFi™ 802.11ac solution (e.g., add-in card that is backward compatible with IEEE 802.11abgn) with support for Windows 8 CS. This card can be configured in an internal slot (e.g., via an NGFF adapter). An additional module may provide for Bluetooth capability (e.g., Bluetooth 4.0 with backwards compatibility) as well as Intel® Wireless Display functionality. In addition, NFC support may be provided via a separate device or multi-function device, and can be positioned as an example, in a front right portion of the chassis for easy access. A still additional module may be a WWAN device that can provide support for 3G/4G/LTE and GPS. This module can be implemented in an internal (e.g., NGFF) slot. Integrated antenna support can be provided for WiFi™, Bluetooth, WWAN, NFC and GPS, enabling seamless transition from WiFi™ to WWAN radios, wireless gigabit (WiGig) in accordance with the Wireless Gigabit Specification (July 2010), and vice versa.

As described above, an integrated camera can be incorporated in the lid. As one example, this camera can be a high-resolution camera, e.g., having a resolution of at least 2.0 megapixels (MP) and extending to 6.0 MP and beyond.

To provide for audio inputs and outputs, an audio processor can be implemented via a digital signal processor (DSP), which may couple to processor via a high definition audio (HDA) link. Similarly, DSP may communicate with an integrated coder/decoder (CODEC) and amplifier that in turn may couple to output speakers which may be implemented within the chassis. Similarly, amplifier and CODEC can be coupled to receive audio inputs from a microphone which in an embodiment can be implemented via dual array microphones (such as a digital microphone array) to provide for high quality audio inputs to enable voice-activated control of various operations within the system. Note also that audio outputs can be provided from amplifier/CODEC to a headphone jack.

In a particular embodiment, the digital audio codec and amplifier are capable of driving the stereo headphone jack, stereo microphone jack, an internal microphone array and stereo speakers. In different implementations, the codec can be integrated into an audio DSP or coupled via an HD audio path to a peripheral controller hub (PCH). In some implementations, in addition to integrated stereo speakers, one or more bass speakers can be provided, and the speaker solution can support DTS audio.

In some embodiments, processor may be powered by an external voltage regulator (VR) and multiple internal voltage regulators that are integrated inside the processor die, referred to as fully integrated voltage regulators (FIVRs). The use of multiple FIVRs in the processor enables the grouping of components into separate power planes, such that power is regulated and supplied by the FIVR to only those components in the group. During power management, a given power plane of one FIVR may be powered down or off when the processor is placed into a certain low power state, while another power plane of another FIVR remains active, or fully powered.

While the above solutions have been described with respect to a limited number of embodiments, those skilled in the art will appreciate numerous modifications and variations therefrom. It is intended that the appended claims cover all such modifications and variations as fall within the true spirit and scope of this present disclosure.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module, engine, or logic as used herein refers to any combination of hardware (e.g., circuitry), software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, e.g., reset, while an updated value potentially includes a low logical value, e.g., set. Note that any combination of values may be utilized to represent any number of states.

The following examples pertain to embodiments in accordance with this Specification.

Example 1 includes an apparatus comprising first circuitry to process a request generated by a first device, the request specifying a memory address range of a second device to monitor for errors; and second circuitry to, based on a determination that a read request targets the memory address range of the second device, compare first data read from the second device with second data read from a memory to determine whether an error has occurred.

Example 2 includes the subject matter of Example 1, and wherein the second circuitry is to report an error to a source of the read request based on a determination that the first data does not match the second data.

Example 3 includes the subject matter of any of Examples 1 and 2, and wherein the second circuitry is to provide the first data and the second data to the source of the read request based on the determination that the first data does not match the second data.

Example 4 includes the subject matter of any of Examples 1-3, and wherein the request is generated by a software application or operating system executed by the first device.

Example 5 includes the subject matter of any of Examples 1-4, and wherein the second circuitry is to compare the first data and second data further based on a sampling rate associated with the memory address range.

Example 6 includes the subject matter of any of Examples 1-5, and wherein the second circuitry is to compare the first data and second data further based on a time interval associated with the memory address range.

Example 7 includes the subject matter of any of Examples 1-6, and wherein the second circuitry is to compare the first data and second data further based on a determination that a source of the read request is specified as a source device in a monitoring rule for the memory address range.

Example 8 includes the subject matter of any of Examples 1-7, and wherein the request specifies multiple memory address ranges of the second device to monitor for errors.

Example 9 includes the subject matter of any of Examples 1-8, and wherein the request specifies one or more interconnect protocols to be monitored for errors.

Example 10 includes the subject matter of any of Examples 1-9, and wherein the memory comprises a plurality of different storage mediums to store write data for different memory address ranges to be monitored for errors, wherein the second circuitry is to assign the memory address range to a storage medium of the storage mediums based on a performance characteristic of the storage medium.

Example 11 includes the subject matter of any of Examples 1-10, and wherein the apparatus comprises a switch comprising the first circuitry, second circuitry, and memory.

Example 12 includes the subject matter of any of Examples 1-11, and wherein the switch is to generate the registration request based on telemetry data collected by the switch.

Example 13 includes a method comprising processing a request generated by a first device, the request specifying a memory address range of a second device to monitor for errors; based on a determination that a write request targets the memory address range of the second device, storing first data of the write request in a memory; and based on a determination that a read request targets the memory address range of the second device, retrieving the first data from the memory and comparing the first data with second data read from the second device to determine whether an error has occurred.

Example 14 includes the subject matter of Example 13, and further including reporting an error to a source of the read request based on a determination that the first data does not match the second data.

Example 15 includes the subject matter of any of Examples 13 and 14, and further including providing the first data and the second data to the source of the read request based on the determination that the first data does not match the second data.

Example 16 includes the subject matter of any of Examples 13-15, and wherein the registration request is generated by a software application or operating system executed by the first device.

Example 17 includes the subject matter of any of Examples 13-16, and further including comparing the first data and second data further based on a sampling rate associated with the memory address range.

Example 18 includes the subject matter of any of Examples 13-17, and further including comparing the first data and second data further based on a time interval associated with the memory address range.

Example 19 includes the subject matter of any of Examples 13-18, and further including comparing the first data and second data further based on a determination that the first device is specified as a source device in a monitoring rule for the memory address range.

Example 20 includes the subject matter of any of Examples 13-19, and wherein the request specifies multiple memory address ranges of the second device to monitor for errors.

Example 21 includes the subject matter of any of Examples 13-20, and wherein the request specifies one or more interconnect protocols to be monitored for errors.

Example 22 includes the subject matter of any of Examples 13-21, and wherein the memory comprises a plurality of different storage mediums to store write data for different memory address ranges to be monitored for errors, and further comprising assigning the memory address range to a storage medium of the storage mediums based on a performance characteristic of the storage medium.

Example 23 includes the subject matter of any of Examples 13-22, and wherein a switch comprises the memory.

Example 24 includes the subject matter of any of Examples 13-23, and further including generating, by a switch, the request based on telemetry data collected by the switch.

Example 25 includes a system comprising a first device comprising a first memory; a second device to generate a request specifying a memory address range of the first device to monitor for errors; and a third device coupled to the first device and second device, the third device comprising a second memory to store data of write requests that target the memory address range of the first device; and circuitry to store, in the second memory, data of write requests that target the memory address range of the first device; and perform error checks for read requests that target the memory address range of the first device by comparing data read from the first device to data retrieved from the second memory.

Example 26 includes the subject matter of Example 25, and wherein the circuitry is to report an error to a source of a read request based on a determination that data read from the first device does not match data retrieved from the second memory.

Example 27 includes the subject matter of any of Examples 25 and 26, and wherein the first device, second device, and third device are each implemented on separate dies.

Example 28 includes the subject matter of any of Examples 25-27, and wherein the second device comprises a central processing unit and the first device comprises one or more of a central processing unit, graphics processing unit, a field programmable gate array, or a network interface controller.

Example 29 includes the subject matter of any of Examples 25-28, and wherein the circuitry is to provide the data read from the first device to data retrieved from the second memory to a source of the read request based on a determination that the data read from the first device does not match the data retrieved from the second memory.

Example 30 includes the subject matter of any of Examples 25-29, and wherein the request is generated by a software application or operating system executed by the first device.

Example 31 includes the subject matter of any of Examples 25-30, and wherein the circuitry is to compare the data read from the first device to data retrieved from the second memory based on a sampling rate associated with the memory address range.

Example 32 includes the subject matter of any of Examples 25-31, and wherein the circuitry is to compare the data read from the first device to data retrieved from the second memory further based on a time interval associated with the memory address range.

Example 33 includes the subject matter of any of Examples 25-32, and wherein the circuitry is to compare the data read from the first device to data retrieved from the second memory further based on a determination that a source of a read request is specified as a source device in a monitoring rule for the memory address range.

Example 34 includes the subject matter of any of Examples 25-33, and wherein the registration request specifies multiple memory address ranges of the second device to monitor for errors.

Example 35 includes the subject matter of any of Examples 25-34, and wherein the request specifies one or more interconnect protocols to be monitored for errors.

Example 36 includes the subject matter of any of Examples 25-35, and wherein the second memory comprises a plurality of different storage mediums to store write data for different memory address ranges to be monitored for errors, wherein the second circuitry is to assign the memory address range to a storage medium of the storage mediums based on a performance characteristic of the storage medium.

Example 37 includes the subject matter of any of Examples 25-36, and wherein the third device comprises a switch.

Example 38 includes the subject matter of any of Examples 25-37, and wherein the switch is to generate the registration request based on telemetry data collected by the switch.

Example 39 includes the subject matter of any of Examples 1-12, wherein the error is a silent data corruption error that is uncorrectable by error correction hardware of the second device.

Example 40 includes the subject matter of any of Examples 1-12 or 39, wherein the switch is a Compute Express Link (CXL) switch.

Example 41 includes an apparatus comprising first circuitry to generate a request specifying a memory address range of a second device to monitor for errors; and second circuitry to transmit the request to a first device that is to monitor the memory address range for errors; and transmit, to the first device, read and write requests for a second device, the second device including the memory address range.

Example 42 includes the subject matter of Example 41, wherein the first circuitry comprises a processor that is to execute software that generates the request.

Example 43 includes the subject matter of Example 41 or 42, wherein the second circuitry is further to receive, from the first device, a notification in connection with a read request for data of memory address range, the notification indicating that a silent data corruption error was detected by the first device.

Example 44 includes the subject matter of any of Examples 41-43, wherein the request specifies a memory address range of a second device to monitor for silent data corruption errors.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
first circuitry to process a request generated by a first device, the request specifying a memory address range of a second device to monitor for errors; and
second circuitry to:
based on a determination that a read request targets the memory address range of the second device, compare first data read from the second device with second data read from a memory to determine whether an error has occurred.

2. The apparatus of claim 1, wherein the error is a silent data corruption error that is uncorrectable by error correction hardware of the second device.

3. The apparatus of claim 1, the second circuitry to report an error to a source of the read request based on a determination that the first data does not match the second data.

4. The apparatus of claim 3, wherein the second circuitry is to provide the first data and the second data to the source of the read request based on the determination that the first data does not match the second data.

5. The apparatus of claim 1, wherein the request is generated by a software application or operating system executed by the first device.

6. The apparatus of claim 1, wherein the second circuitry is to compare the first data and second data further based on a sampling rate associated with the memory address range.

7. The apparatus of claim 1, wherein the second circuitry is to compare the first data and second data further based on a time interval associated with the memory address range.

8. The apparatus of claim 1, wherein the second circuitry is to compare the first data and second data further based on a determination that a source of the read request is specified as a source device in a monitoring rule for the memory address range.

9. The apparatus of claim 1, wherein the request specifies multiple memory address ranges of the second device to monitor for errors.

10. The apparatus of claim 1, wherein the request specifies one or more interconnect protocols to be monitored for errors.

11. The apparatus of claim 1, wherein the memory comprises a plurality of different storage mediums to store write data for different memory address ranges to be monitored for errors, wherein the second circuitry is to assign the memory address range to a storage medium of the storage mediums based on a performance characteristic of the storage medium.

12. The apparatus of claim 1, wherein the apparatus comprises a switch comprising the first circuitry, second circuitry, and memory.

13. The apparatus of claim 12, wherein the switch is a Compute Express Link (CXL) switch.

14. The apparatus of claim 12, wherein the switch is to generate the request based on telemetry data collected by the switch.

15. A method comprising:
processing a request generated by a first device, the request specifying a memory address range of a second device to monitor for errors;
based on a determination that a write request targets the memory address range of the second device, storing first data of the write request in a memory; and
based on a determination that a read request targets the memory address range of the second device, retrieving the first data from the memory and comparing the first data with second data read from the second device to determine whether an error has occurred.

16. The method of claim 15, further comprising reporting an error to a source of the read request based on a determination that the first data does not match the second data.

17. The method of claim 16, further comprising providing the first data and the second data to the source of the read request based on the determination that the first data does not match the second data.

18. The method of claim 15, wherein the request is generated by a software application or operating system executed by the first device.

19. A system comprising:
a first device comprising a first memory;
a second device to generate a request specifying a memory address range of the first device to monitor for errors; and
a third device coupled to the first device and second device, the third device comprising:
a second memory to store data of write requests that target the memory address range of the first device; and
circuitry to:
store, in the second memory, data of write requests that target the memory address range of the first device; and
perform error checks for read requests that target the memory address range of the first device by comparing data read from the first device to data retrieved from the second memory.

20. The system of claim 19, the circuitry to report an error to a source of a read request based on a determination that data read from the first device does not match data retrieved from the second memory.

21. The system of claim 19, wherein the first device, second device, and third device are each implemented on separate dies.

22. The system of claim 19, wherein the second device comprises a central processing unit and the first device comprises one or more of a central processing unit, graphics processing unit, a field programmable gate array, or a network interface controller.

23. An apparatus comprising:
first circuitry to generate a request specifying a memory address range of a second device to monitor for errors; and
second circuitry to:
transmit the request to a first device that is to monitor the memory address range for errors; and
transmit, to the first device, read and write requests for a second device, the second device including the memory address range.

24. The apparatus of claim 23, wherein the first circuitry comprises a processor that is to execute software that generates the request.

25. The apparatus of claim 23, wherein the second circuitry is further to receive, from the first device, a notification in connection with a read request for data of memory address range, the notification indicating that a silent data corruption error was detected by the first device.
